(19) United States
(12) Patent Application Publication
(10) Pub. No.: US 2017/0008048 A1
(43) Pub. Date: Jan. 12, 2017

(54) Albee Arctic Kick-ice System "Column of Defiance" forced air moisture and particle barrier

(71) Applicant: Robert Clarke Albee, Longmont, CO (US)

(72) Inventor: Robert Clarke Albee, Longmont, CO (US)

(73) Assignee: Atomic Thunder Engineering Ltd., Longmont, CO (US)

(21) Appl. No.: 14/738,585

(22) Filed: Jul. 6, 2015

(51) Int. Cl. B08B 17/02

(52) U.S. Cl. CPC B08B 17/02

(57) ABSTRACT

There are many manufactures, makes, and models of solar radiometers to choose from. There are also many radiometer housings to choose from. I have not observed or deployed any of the combinations available for solar radiometers to satisfy the requirements of unattended perfect solar radiation measurements in cold climates. There is a large expense involved with deploying radiometers in remote Arctic and Alpine regions. Huge expense is continually lost due to the lack of consistent quality data. My concept has continually proven and guarantees that time and money will not be lost. This was proven with an intensive parametric comparison study that by focusing a volume of air with the proper amount of force, specifically with the Albee Arctic Kick-ice System Radiometer Housing (Patent pending #61/934,754, Patent pending #62/107,441), is completely effective in combating all icing issues using a variety of radiometers from quality radiometer manufacturers. Being able to deploy solar radiation instruments in harsh environments with confidence will save huge amounts of money and bring solar radiation science to a higher level of success.

The Albee Arctic Kick-ice System “Column of Defiance” forced air moisture and particle barrier or (AAKS Column of Defiance) is the key discovery and primary component of the Albee Arctic Kick-ice System/Radiometer Dome Sub-system provisional patent pending application Nos. 61/934,754 & 62/107,441 & 62/031,121. Column of air shown in embodiment FIG. 4 02 & FIG. 5 03.

My invention and discovery of the Column of Defiance has been extensively proven beyond any doubt that by forcing air with positive pressure over a radiometer dome with calculative precision will deflect contaminated air, air molecules, moisture, and debris which prevents the accumulation of any unwanted material on the optical glass or quartz dome shown in embodiment FIG. 1 01

### BACKGROUND OF INVENTION

While visiting observatories in the Arctic it became quite obvious that radiometers do not remain free from ice, frost, or rime. I noticed that a variety of radiometers being deployed in cold regions are placed within housings that are not intended to be in Arctic conditions. Solar radiometers need to be able to collect accurate and precision measurements at temperatures far below −40 Celsius , high humidity, and with wind speeds and gusts over 150 Kilometers per Hour without collecting heavy concentrations of ice and snow. Radiometers placed in these conditions require constant monitoring, maintenance, and cleaning by human beings. Although people are able to have a positive impact on the from continually reoccurring.

While drinking coffee and eating doughnuts it became quite clear to me that the solution to this problem is to create a column of air to deflect the problematic dynamic processes within close proximity of the dome that effect the collection of ice and snow on the radiometer dome. I carefully designed a system that is becoming known as the Albee Arctic Kick-ice System—Radiometer Dome Sub-system with multiple configurations. After 18 months of extensive and ongoing testing of the AAKS Column of Defiance I have proven beyond any reasonable doubt that this concept works as promised without fail. This system relies on a column of air to be strategically created above and around the glass dome with forced air originating from a well designed gap where the base of the dome is near the AAKS radiometer dome housing.

### BRIEF SUMMARY OF INVENTION

By placing a radiometer in the AAKS-RDS aspirated radiometer dome housing with either a fan, forced air, or blower, the transparent dome made of either glass, quartz, or other materials will remain perfectly clean to allow the radiometer to make perfect solar radiation measurements without the need for the heat or spray system during most weather conditions when installed correctly in Arctic, Antarctic, and Alpine environments.

### DETAILED DESCRIPTION OF INVENTION

When a glass dome is placed in an environment below freezing and the dew point temperature is above the ambient temperature types of ice will form and grow on the exposed glass surface. Since perfect measurements of solar radiation require perfectly clean domes ice causes the data to become invalid.

My invention is that when a column of dry air is forced across the dome with calculated pressure and flow rate a barrier is established that deflects surrounding air, moisture, and debris away from the dome preventing the accumulation of ice. Reference DOI: 0.13140/RG.2.1.4683.1528

### BRIEF DESCRIPTION OF DRAWINGS

FIG. 1 is a drawing of EPLAB Inc. radiometer depicting the glass dome.

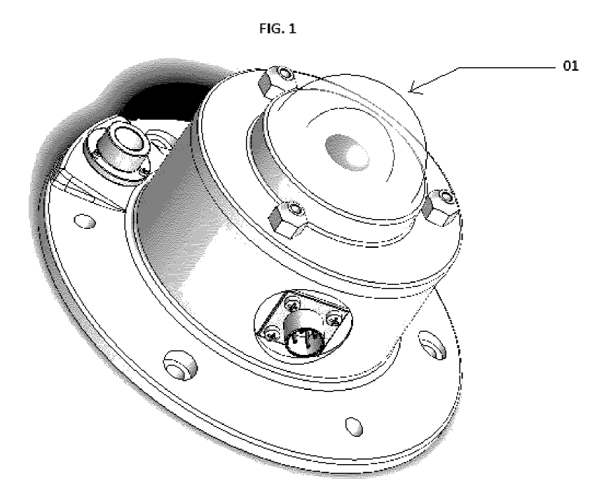

FIG. 2 is a drawing of the (Patent pending #61/934,754) AAKS radiometer housing

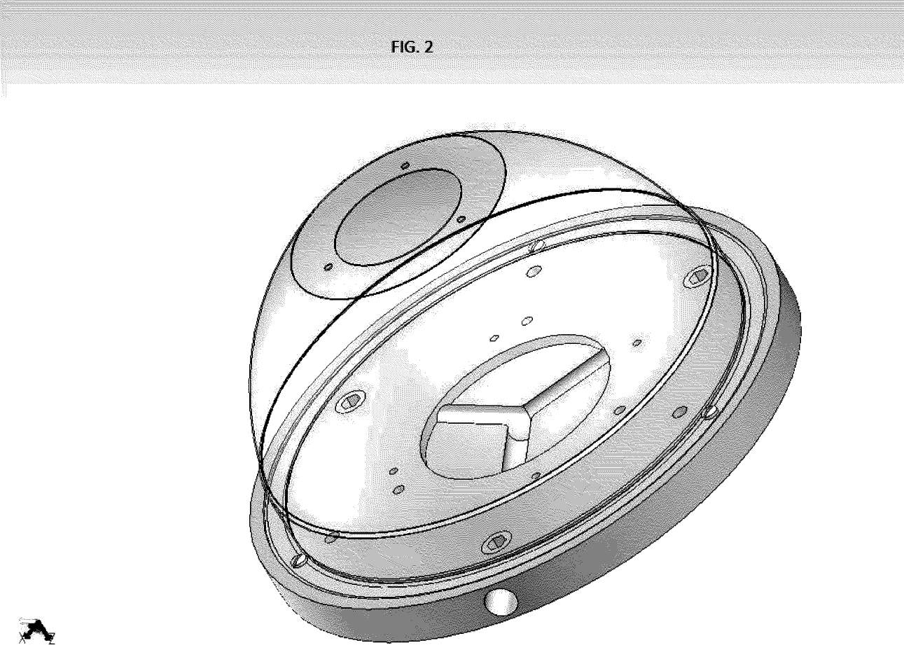

FIG. 3 is a drawing of EPLAB inc. radiometer mounted inside the (Patent pending #61/934,754) AAKS radiometer housing

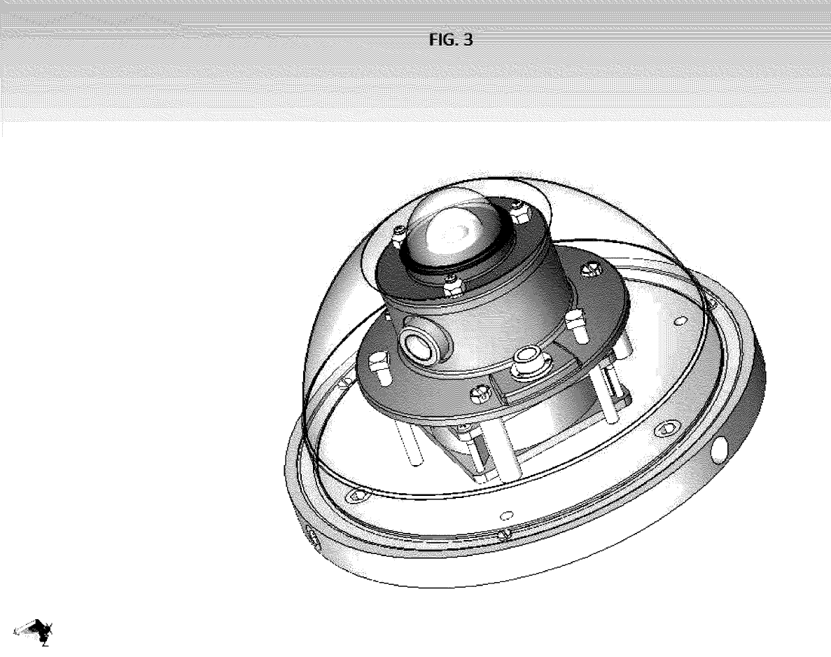

FIG. 4 is a drawing of a flow simulation depicting the density of the air column created around the glass dome

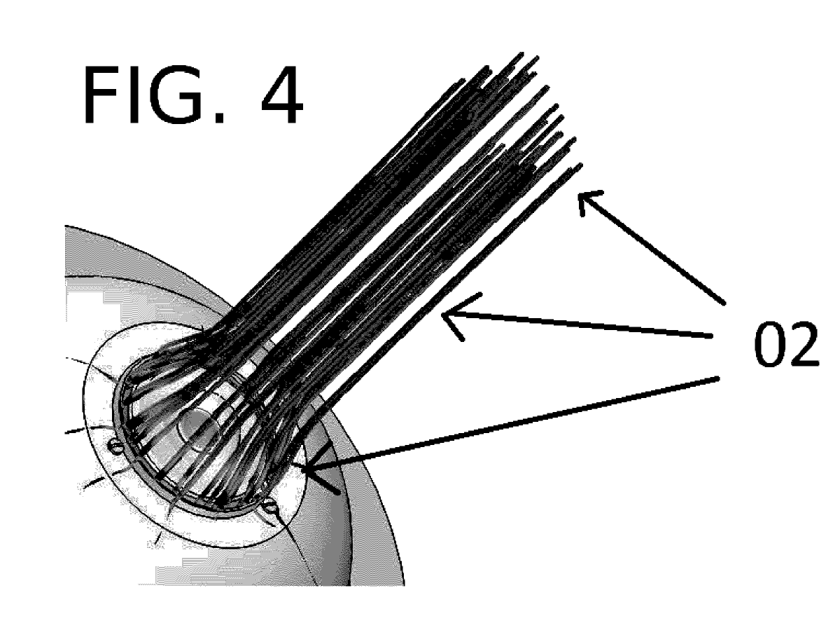

FIG. 5 is a drawing of a flow simulation depicting the velocity of the air column created around the glass dome

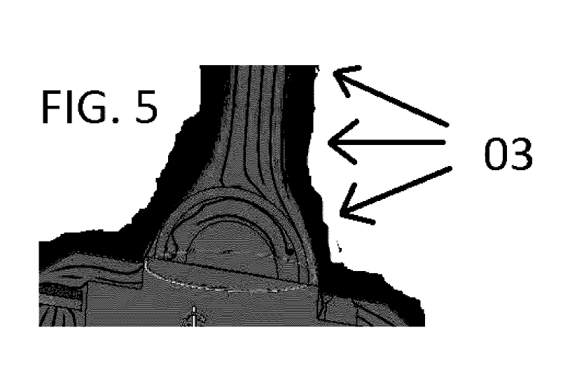

1. I claim that my properly engineered Column of air is all that is required in all Arctic, Antarctic, or Alpine conditions to keep a radiometer that are properly installed in the Albee Arctic Kick-ice System clean from any kind of ice, rime ice, hoar frost, freezing rain, freezing fog, or snow by deflecting ice crystals, condensation, humid air, water droplets, snow, and other components of the nearby air mass that would otherwise form ice without the Column of air.
